(19) United States
(12) Patent Application Publication
(10) Pub. No.: US 2004/0053804 A1
(43) Pub. Date: Mar. 18, 2004

(54) Liquid detergent composition

(76) Inventors: Yoshihiro Yomogida, Wakayama (JP); Nobuhiro Nishizawa, Wakayama (JP); Kazunari Maruta, Wakayama (JP); Nobuyuki Ogura, Wakayama (JP)

Correspondence Address: BIRCH STEWART KOLASCH & BIRCH, PO BOX 747, FALLS CHURCH, VA, 22040-0747, US

(21) Appl. No.: 10/466,691

(22) PCT Filed: Jan. 18, 2002
(86) PCT No.: PCT/JP02/00347

(30) Foreign Application Priority Data
Jan. 23, 2001 (JP) 2001-14881

(51) Int. Cl. C11D 17/00

(52) U.S. Cl. 510/424

(57) ABSTRACT

In a method of washing with a flexible absorber impregnated with a small amount of water and a detergent solution, there is provided a liquid detergent composition exhibiting a high detergent effect and durability of the effect. Disclosed is a liquid detergent composition for use in direct impregnation of specific amounts of a flexible absorber, which comprises a surfactant, a hydrotropic agent and a water-soluble organic solvent and water, has a viscosity of 300 to 1000 mPa·s at 20° C., and has the maximum viscosity when diluted with water within the concentration range of 10 to 60% by weight.

### TECHNICAL FIELD

The present invention relates to a liquid detergent composition. The present invention relates in particular to a liquid detergent composition suitable for a method of washing by impregnating a flexible absorber such as a sponge or a towel directly therewith and rubbing, together with water, the surface of an article to be washed.

### BACKGROUND ART

Detergents are required to exhibit high detergency for removing persistent dirt adhering to an article to be washed and the durability of a washing operation that can be carried out in an impregnation operation of impregnating a flexible absorber once with a detergent. In particular, washing of tableware or cookware by rubbing with a flexible absorber such as a sponge or a towel while directly contacting the tableware or cookware with an aqueous dilution of a detergent is known, but a method of washing by rubbing tableware etc. with a flexible absorber impregnated directly with a detergent and a small amount of water is common in Japan, Brazil and India, and in such a method too, there is a demand for a durable liquid detergent capable of washing much tableware in one impregnation treatment.

International Patent Publication No. (JP-A) 11-503477 discloses a washing method wherein an adsorption carrier such as a sponge is impregnated with a surfactant composition capable of being thickened with a small amount of water, and then the adsorption carrier and the surfactant composition are treated with water thereby thickening the surfactant composition in the adsorption carrier, to prolong the release of the surfactant. However, the washing effect itself of this prior art technique is not satisfactory. As far as specific liquid detergents described in the Examples therein are concerned, the plotting of the concentrations of the detergents diluted with water on the abscissa and the viscosity thereof upon dilution on the ordinate reveals that the maximum viscosity of the diluted detergents is attained at concentrations as high as 80% by weight, and thus the detergents are easily released thus failing to exhibit its sufficient sustainable effect.

International Patent Publication No. (JP-A) 11-513067 discloses a technique regarding a dish detergent, wherein a detergent solution containing a surfactant at high concentration is dissolved in water without causing gelation. This technique prevents gelation of the detergent containing a surfactant at high concentration by compounding it with a gelation inhibitor. However, the composition disclosed in the publication supra, when used in washing with a flexible absorber impregnated with a small amount of water and the detergent solution, cannot wash much tableware.

Japanese Patent Laid-Open No. (JP-A) 6-33099 describes a liquid detergent comprising a surfactant, a pearling agent, and a viscosity regulator and having a viscosity of 200 to 4000 cps (mPa·s) and a Brookfield yield value of 5 to 100 p, but this prior art technique makes the amount of the squeezed liquid detergent upon direct application to a sponge easily visually recognized by using the pearling agent and the specific viscosity, but is not a technique improving the durability of a washing effect by washing tableware etc. by rubbing with a flexible absorber impregnated directly with the liquid detergent.

Japanese Patent Laid-Open Nos. (JP-A) 2000-248293 and 2000-273500 describe a detergent for tableware, which after diluted 5-fold, requires viscosity in the range of 100 to 1000 mPa·s, preferably 200 to 800 mPa·s, but in these publications, the detergent prepared by diluting a stock solution is used, and the stock solution itself is not used by directly impregnating a flexible absorber therewith.

### DISCLOSURE OF THE INVENTION

The object of the present invention is to provide a liquid detergent composition exhibiting a high washing effect and durability of the washing effect in a method of washing articles such as tableware with a flexible absorber impregnated with a small amount of water and a detergent solution.

The present invention relates to a liquid detergent composition for use in direct impregnation of a flexible absorber, which comprises 30 to 60% by weight of a surfactant, 0.01 to 5% by weight of a hydrotropic agent, 0.01 to 10% by weight of a water-soluble organic solvent and water, has a viscosity of 300 to 1000 mPa·s at 20° C., and has the maximum viscosity when diluted with water at 20° C. within the concentration range of 10 to 60% by weight. Further, the present invention relates to a method of washing a hard surface by using a flexible absorber impregnated with the liquid detergent composition and water.

The viscosity referred to in the present invention is measured in the following manner. First, a Brookfield viscometer model BM manufactured by TOKIMEC INC. is equipped with Rotor No. 3. A sample is charged into a tall beaker and kept at 20° C. in a thermostatic bath at 20° C. The sample kept at the constant temperature is set to the viscometer. Revolution number is set to 30 rpm, and the viscosity after revolution for 60 seconds is referred to as the viscosity in the present invention.

The concentration of the liquid detergent composition upon dilution, referred to in the present invention, refers to the concentration of the liquid detergent composition when diluted with water. For example, the concentration of 60% by weight upon dilution means that 60 parts by weight of the liquid detergent are mixed with 40 parts by weight of water.

### DETAILED DESCRIPTION OF INVENTION

<Viscosity Characteristics of the Liquid Detergent Composition>

The liquid detergent composition of the present invention has a viscosity at 20° C. of 300 to 1000 mPa·s, more preferably 400 to 900 mPa·s, most preferably 500 to 900 mPa·s. Given too high viscosity, the impregnation of a flexible absorber therewith is time-consuming so that when a washing operation is initiated, the detergent composition adheres excessively to the surface of an article to be washed, thus wasting the detergent. Given too low viscosity, the release of the detergent composition is accelerated, thus failing to achieve sufficient durability of washing.

With respect to the durability of washing, JP-A 11-503477 supra discloses that the release of a surfactant from a sponge can be controlled by using a surfactant composition which can be thickened by adding a small amount of water, and the Examples therein illustrate compositions which can be thickened at low degrees of dilution. However, the present inventors found, through actually conducted experiments, that it is important for the detergent not to be easily thickened in a sponge but to have a property of thickening at a relatively high degree of dilution, in order to achieve sufficient durability of washing. Specifically, when the detergent composition is diluted with water, the detergent composition at a concentration in the range of 10 to 60% by weight, preferably 10 to 50% by weight, exhibits the maximum viscosity. In this case, the maximum viscosity may be lower than the viscosity of the detergent composition before dilution.

More preferable viscosity characteristics make the maximum viscosity preferably higher than 1000 mPa·s, more preferably more than 1200 mPa·s, and not greater than 2500 Pa·s, particularly not greater than 2000 Pa·s, from the viewpoint of usability.

<Surfactant>

A surfactant preferably used for achieving the viscosity characteristics defined in the present invention or from the viewpoint of detergency is a polyoxyalkylene alkyl ether sulfate having a C₁₀₋₁₆, preferably C₁₀₋₁₄ alkyl group, more preferably a polyoxyalkylene alkyl ether sulfate produced from an alcohol whose alkyl group is a branched primary alkyl group, most preferably from a branched alcohol obtained by hydroformylation of linear 1-alkene, in order to adjust the composition to the desired viscosity. The “hydroformylation” refers to a method of obtaining an alcohol containing a linear alkyl group and a methyl-branched alkyl group by adding carbon monoxide to linear 1-alkene by using, as a catalyst, a carbonyl complex with iron, cobalt or nickel. In the present invention, an alkylene oxide, preferably propylene oxide (hereinafter, abbreviated as PO) or ethylene oxide (abbreviated hereinafter as EO), more preferably EO is added to the above alcohol. The average number of PO or EO molecules added to one alcohol molecule is preferably 1.5 to 6.0, more preferably 1.6 to 4.0, most preferably 1.8 to 3.0, in order to achieve detergency and desired viscosity. The alkylene oxide adduct thus obtained is sulfonated with sulfur trioxide or chlorosulfonic acid and neutralized with an alkali, whereby the polyoxyalkylene alkyl ether sulfate can be obtained. The alkali is preferably sodium hydroxide, potassium hydroxide, magnesium hydroxide, sodium carbonate, potassium carbonate, magnesium carbonate, ammonia, monoethanolamine or diethanolamine, more preferably sodium hydroxide, potassium hydroxide or magnesium hydroxide. The polyoxyalkylene alkyl ether sulfate thus obtained includes a polyoxyalkylene branched alkyl ether sulfate, and the proportion of the polyoxyalkylene branched alkyl ether in the total polyoxyalkylene alkyl ether sulfate is 20 to 70% by weight, more preferably 20 to 60% by weight, in order to achieve the desired viscosity.

The liquid detergent composition of the present invention comprises preferably 15 to 50% by weight, more preferably 20 to 45% by weight, still more preferably 25 to 40% by weight of the polyoxyalkylene alkyl ether sulfate, in order to achieve a washing effect and adjust the composition to the desired viscosity.

The liquid detergent composition of the present invention preferably comprises an amine oxide-based surfactant in order to achieve the desired viscosity. The amine oxide-based surfactant has one C₈₋₁₈ alkyl or alkenyl group and two C₂ or less alkyl groups.

For shifting the degree of dilution with water at which the maximum viscosity appears to a higher degree of dilution, the amine oxide-based surfactant is most preferably a compound of formula (i):

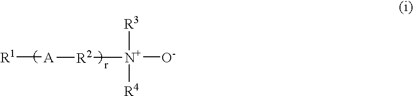

wherein R¹ represents a C₈₋₁₆, preferably C₁₀₋₁₆, more preferably C₁₀₋₁₄ linear alkyl or alkenyl group, R³ and R⁴ each represents a C₁₋₃ alkyl or hydroxyalkyl group, R² represents a C₁₋₅, preferably C₂₋₃ alkylene group, A is a group selected from —COO—, —CONH—, —OCO—, —NHCO—, and —O—, preferably a —CONH— group, and r is a number of 0 or 1.

The liquid detergent composition of the present invention comprises preferably 1 to 10% by weight, more preferably 3 to 9% by weight of the amine oxide-based surfactant. To achieve the viscosity characteristics in the present invention, the polyoxyalkylene alkyl ether sulfate/amine oxide-based surfactant ratio by weight is preferably from 2/1 to 10/1, more preferably from 3/1 to 10/1.

For improving the washing effect and simultaneously regulating the viscosity, the liquid detergent composition of the present invention is compounded preferably with a nonionic surfactant selected from those of the following formulae (ii) to (iv) in an amount of preferably 1 to 20% by weight, more preferably 3 to 15% by weight.

R⁵—O(EO)ₙH (ii)

wherein R⁵ is a primary linear or branched alkyl or secondary alkyl group containing 10 to 20 carbon atoms on the average, preferably 10 to 18 carbon atoms, EO is ethylene oxide, and n is a number of 5 to 20 as the average number of molecules added.

R⁶—O[(EO)ₚ/(PO)_{q}]H (iii)

wherein R⁶ is a primary alkyl group containing 10 to 20 carbon atoms on the average, preferably 10 to 18 carbon atoms, EO is ethylene oxide, PO is propylene oxide, p is 5 to 15, g is 1 to 5, and EO and PO may be added at random, or added to form a block addition product by first adding EO and then PO or vice versa.

R⁷—(OR⁸)ₓG_{y} (iv)

wherein R⁷ represents a linear or branched C₈₋₁₈ alkyl, alkenyl or alkyl phenyl group, R⁸ represents a C₂₋₄ alkenyl group, G represents a residue derived from C₅ or C₆ reducing sugar, X is a number of 0 to 6 on the average, y is a number of 1 to 10 on the average.

In the present invention, the compound of formula (ii) or (iv) is preferable, and particularly one or more of secondary alkyl nonionic surfactants of formula (ii) and/or compounds of formula (iv) wherein the average degree of condensation, y, of reducing sugar is 1 to 3 are used most preferably.

In the present invention, a betaine amphoteric surfactant represented by the following formulae (v) and/or (vi) is preferably contained to exhibit the viscosity characteristics even at high degrees of dilution.

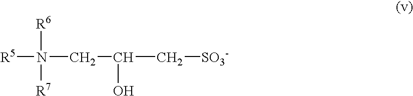

wherein R⁵ represents a C₈₁₆, preferably C₁₀₋₁₆, more preferably C₁₀₋₁₄ linear alkyl or alkenyl group, and R⁶ and R⁷ each represents a C₁₃ alkyl or hydroxyalkyl group.

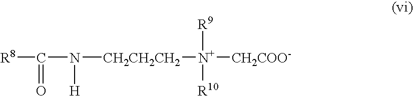

wherein R⁸ represents a C₈₋₁₆, preferably C₁₀₋₁₆, more preferably C₁₀₋₁₄ linear alkyl or alkenyl group, and R⁹ and R¹⁰ each represents a C₁₋₃ alkyl or hydroxyalkyl group.

The liquid detergent composition of the present invention can be compounded with a surfactant other than those described above, but it is important that the desired viscosity is not spoiled. As the anionic surfactant, a linear alkylbenzene sulfonate, an α-sulfofatty acid ester salt, an α-olefin sulfonate and an alkane sulfonate may be compounded, and the amount of the anionic surfactant compounded is preferably not higher than 5% by weight, more preferably not higher than 3% by weight, in order to satisfy the properties described above.

The liquid detergent composition of the present invention comprises preferably 0.5 to 10% by weight, more preferably 1 to 5% by weight of an alkali metal and/or an alkaline earth metal. In the present invention, the alkali metal and alkaline earth metal encompass those ionized and those not dissociated. The present inventors found that in a system wherein a relatively large amount of the polyoxyalkylene alkyl ether sulfate is present, in a small composition within a specific viscosity, the alkali metal and/or alkaline earth metal at a predetermined concentration exert an effect on stabilization of viscosity. The alkali metal is preferably sodium or potassium, and the alkaline earth metal is preferably magnesium, and particularly magnesium is contained preferably in an amount of 1 to 50% by weight, preferably 3 to 40% by weight, based on the total of the alkali metal and alkaline earth metal, in order to adjust the composition to the viscosity in the present invention. In the present invention, the amount of the alkali metal and alkaline earth metal includes any counter ions from the anionic surfactant and incorporated metals derived from other components, and when the content of the alkali metal and alkaline earth metal is insufficient, at least one inorganic salt selected from sodium sulfate, potassium sulfate, magnesium sulfate, sodium chloride, potassium chloride, magnesium chloride, sodium hydroxide, potassium hydroxide and magnesium hydroxide may be added such that the total content is in the range described above. When the content is too high, salts are preferably removed by techniques such as electrodialysis. Such alkali metal and/or alkaline earth metal can be determined by quantifying the whole composition for example by an inorganic analysis method such as usual atomic-absorption method.

<Hydrotropic Agent>

The liquid detergent composition of the present invention preferably comprises a hydrotropic agent for the purpose of improving shelf stability, but attention should be paid to satisfy the conditions in the present invention. The hydrotropic agent is preferably toluenesulfonic acid, xylenesulfonic acid, cumenesulfonic acid or a sodium, potassium or magnesium salt thereof, particularly preferably p-toluenesulfonic acid. To achieve the desired viscosity characteristics, the composition of the present invention comprises 0.01 to 5% by weight, preferably 0.5 to 5% by weight, most preferably 1 to 5% by weight of the hydrotropic agent.

<Water-Soluble Organic Solvent>

For adjustment to the water-soluble viscosity intended in the present invention, a solvent is preferably compounded. The solvent includes (1) a C₁₋₅ monovalent alcohol, (2) a C₄₋₁₂ polyvalent alcohol, (3) a compound represented by formula (vii) below, (4) a compound represented by formula (viii) below, and (5) a compound represented by formula (ix) below.

R¹¹O(C₂H₄O)ₛ(C₃H₆O)ₜR¹² (vii) 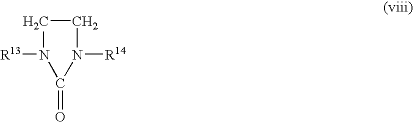
R¹⁵OCH₂CH(OH)CH₂OH (ix)

wherein R¹¹ and R¹² each represents a hydrogen atom, a C₁₋₆ alkyl group, a phenyl group or a benzyl group provided that R¹¹ and R¹² are not simultaneously hydrogen atoms, s is a number of 0 to 10 and t is a number of 0 to 10 provided that s and t are not simultaneously 0, R¹³ and R¹⁴ each represents a C₁₃ alkyl group, and R¹⁵ represents a C₁₋₈ alkyl group.

Generally, the C₂₋₅ monovalent alcohol (1) includes ethanol, propyl alcohol and isopropyl alcohol. By compounding these lower alcohols, the stability of the system at low temperatures can be further improved.

The C₄₋₁₂ polyvalent alcohol (2) includes isoprene glycol, 2,2,4-trimethyl-1,3-pentanediol, 1,8-octanediol, 1,9-nonanediol, ethylene glycol, propylene glycol, diethylene glycol, dipropylene glycol, glycerine, etc.

The compound (3) is particularly preferably a compound wherein when R¹¹ and R¹² in the formula (vii) represent an alkyl group, the number of carbon atoms in the alkyl group is 1 to 4. In the formula (vii), s or t, that is, the average number of EO or PO molecules added, is a number of 0 to 10 provided that sand tare not simultaneously 0, and the EO or PO molecules may be added at random without particular limitation to the order of addition thereof. Examples of the compound (3) include ethylene glycol monobutyl ether, dipropylene glycol dimethyl ether, diethylene glycol monoethyl ether, diethylene glycol monobutyl ether, propylene glycol monomethyl ether, propylene glycol monobutyl ether, propylene glycol monoethyl ether, propylene glycol dimethyl ether, polyoxyethylene (p=2 to 3) polyoxypropylene (p=2 to 3) glycol dimethyl ether (p is the average number of molecules added), polyoxyethylene (p=3) glycol phenyl ether, phenyl carbitol, phenyl cellosolve, benzyl carbitol, etc. Among these compounds, propylene glycol monomethyl ether, diethylene glycol monobutyl ether, and polyoxyethylene (p=1 to 4) glycol phenyl ether are preferable from the viewpoint of detergency and feeling in use.

Preferable examples of the compound (4) include 1,3-dimethyl-2-imidazolidinone and 1,3-diethyl-2-imidazolidinone, and preferable examples of the compound (5) include alkyl glyceryl ether compounds, and particularly those compounds of formula (ix) wherein R¹⁵ is a C₃₋₈ alkyl group are preferable.

To satisfy the properties in the present invention, the water-soluble organic solvents (1), (2), (3) and (5) are preferable, and particularly a water-soluble organic solvent selected from ethanol, isopropyl alcohol, ethylene glycol, propylene glycol, diethylene glycol, dipropylene glycol, glycerine, isoprene glycol, propylene glycol monomethyl ether, propylene glycol monoethyl ether, pentyl glyceryl ether and octyl glyceryl ether is preferable.

The liquid detergent composition of the present invention contains preferably 1 to 10% by weight, more preferably 3 to 8% by weight of the water-soluble organic solvent, in order to regulate the viscosity. However, a lower alcohol such as ethanol, when added even in a small amount, causes not only a change in the properties of the liquid detergent composition upon dilution, but also gelation and clogging in a discharge opening of a container, and should thus be carefully compounded such that the content of ethanol and/or isopropyl alcohol is preferably not more than 3% by weight, more preferably not greater than 2.8% by weight, based on the composition.

Preferably, ethanol and propylene glycol are simultaneously used in the present invention. The ethanol/propylene glycol ratio by weight is preferably from 1/5 to 1/1, more preferably 1/4 to 1/5.

<Gelation-Inhibiting Polymer>

Suitable viscosity may be achieved by incorporation of a polymer for preventing gelation, for example, a gelation-preventing polymer described in JP-A 11-513067 supra, particularly polyalkylene glycol, but the gelation-inhibiting polymer may achieve suitable viscosity upon incorporation, but exhibits a property of lowering viscosity upon dilution and is thus preferably not incorporated in order to achieve the viscosity characteristics in the present invention. The allowable concentration of polyalkylene glycol is not higher than 2.0% by weight, more preferably not higher than 1.5% by weight, most preferably not higher than 0.4% by weight, but ideally it is preferable to design the composition without incorporating polyalkylene glycol. Specific examples of the polyalkylene glycol for preventing gelation include polyethylene glycol and polypropylene glycol having a weight-average molecular weight of 200 to 3000 determined by gel permeation chromatography using polyethylene glycol as standards.

<Water and Other Compounding Ingredients>

The composition of the present invention is in the form of an aqueous solution prepared by compounding the above ingredients and water, and the content of water is preferably 20 to 60% by weight, more preferably 30 to 60% by weight, more preferably 40 to 60% by weight, still more preferably 45 to 55% by weight, from the viewpoint of viscosity. The pH value of the composition at 20° C. is 6 to 8, preferably 6.5 to 7.5, from the viewpoint of shelf stability and safety for the skin. As a pH regulator, acids including inorganic acids such as hydrochloric acid and sulfuric acid and organic acids such as citric acid, succinic acid, malic acid, fumaric acid, tartaric acid, malonic acid and maleic acid, sodium hydroxide, potassium hydroxide and ammonia or derivatives thereof, amine salts such as monoethanolamine, diethanolamine and triethanolamine, and alkalis such as sodium carbonate and potassium carbonate are used alone or in combination thereof, and particularly an acid selected from hydrochloric acid, sulfuric acid and citric acid and an alkali selected from sodium hydroxide and potassium hydroxide are preferably used. Any of these compounds are compounded in such a range that the viscosity characteristics are not significantly influenced.

As other ingredients, ingredients incorporated usually into liquid detergents can be compounded insofar as the viscosity characteristics are not influenced. For example, a perfume ingredient, a preservative, a clouding agent and a coloring agent can be mentioned.

<Flexible Absorber and Washing Method>

The present invention also provides a method of washing a hard surface by using a flexible absorber impregnated with the liquid detergent composition described above and water.

The liquid detergent composition showing the viscosity characteristics is the most suitable liquid detergent composition for the method of washing the surface of an article by impregnation of a flexible absorber directly therewith and then rubbing, together with a small amount of water, the surface (preferably hard surface) of the article to be washed, and exhibits excellent detergency and durability of washing for particularly tableware and cookware.

The term “impregnation” means that the liquid detergent composition sinks into a flexible absorber. The flexible absorber is preferably a sponge or a scrubbing brush made of a material such as polyvinyl chloride, polyvinylidene chloride, nylon, polypropylene, polyester, cellulose, polyacrylamide or polyurethane, particularly preferably polyurethane or cellulose. In one washing process, the flexible absorber is impregnated preferably with 0.1 to 2 g detergent in the present invention. Whether the operation of impregnating a flexible absorber with water or the operation of impregnating it with the liquid detergent composition is first carried out, the liquid detergent composition having the viscosity characteristics in the present invention can achieve excellent durability of washing, and this also applies to additional washing. The method of washing tableware in the present invention comprises a step of washing a hard surface of tableware etc. with a flexible absorber impregnated with the composition and water. Preferably, this step involves washing tableware by directly rubbing with the flexible absorber impregnated with the composition. After washing, the tableware is washed with running water.

### EXAMPLE

Liquid detergent compositions were prepared from the ingredients shown in Table 1. The change in the viscosity of these compositions and the detergency thereof were evaluated in the following methods. The results are shown in Table 1.

<Measurement of Viscosity>

Method of Measuring the Viscosity of the Liquid Detergent Composition

A Brookfield viscometer model BM manufactured by TOKIMEC INC. equipped with Rotor No. 3 is equipped. A liquid detergent composition in Table 1 is charged into a beaker for measuring viscosity and kept at 20° C. in a thermostatic bath at 20° C. The sample kept at the constant temperature is set to the viscometer. Revolution number of the motor is set to 30 rpm, and the viscosity after for 60 seconds is for the liquid detergent composition.

Method of Measuring the Viscosity of the Diluted Liquid Detergent Composition

A composition in Table 1 is diluted to 20, 40, 60 and 80% by weight with deionized water or distilled water and uniformly stirred. The diluted composition is transferred to a beaker for measuring viscosity and kept at 20° C. in a thermostatic bath at 20° C. The sample kept at the constant temperature is set to the viscometer. Revolution number of the motor is set to 30 rpm, and the viscosity after revolution for 60 seconds is measured.

<Detergency Test>

Salad oil/tallow was mixed in a ratio of 1/1 by weight and then mixed uniformly with 0.1% by weight of a coloring matter (Stan Red), and the resulting model oil dirty, 2 g, was spread uniformly on melamine dishes, to prepare model polluted dishes.

A commercial sponge (flexible absorber, Kincho Cleaner No. 5005, polyurethane foam) was impregnated with 1 g composition in Table 1 and 15 g tap water and lathered by crumpling twice or thrice by hands. This sponge was used to wash the model polluted dishes by rubbing, and the number of dishes that could be washed (washing was confirmed by disappearance of the color on the dishes) was determined.

TABLE 1

| | | | Example | | | | | Comparative example | | |
|---|---|---|---|---|---|---|---|---|---|---|
| | | | 1 | 2 | 3 | 4 | 5 | 1 | 2 | 3 |
| Liquid | Composition (weight-%) | ES-I | 30.0 | 25.0 | 30.0 | 30.0 | 30.0 | 22.0 | 36.0 | |
| detergent | | ES-II | | 5.0 | | | | | | |
| composition | | ES-III | | | | | | | | 18.0 |
| | | AS | | | | | | 4.0 | | |
| | | AO-I | 3.6 | 3.0 | 6.0 | 5.5 | 5.5 | 7.0 | 4.0 | 11.0 |
| | | AO-II | 1.5 | 3.0 | | | 1.0 | | | |
| | | Nonion-I | | | 4.0 | | | | | |
| | | Nonion-II | 4.0 | 2.0 | 4.0 | 4.0 | 4.0 | | | 4.0 |
| | | Nonion-III | | 1.0 | | | | 6.0 | 3.0 | |
| | | Betaine | | | | | | 1.5 | | |
| | | Amide propyl betaine | | | | | 3.0 | | | |
| | | Sulfobetaine | 2.0 | 1.5 | 1.5 | 2.0 | | | | 3.0 |
| | | Fatty acid diethanol amide | | | | | | | | 10.0 |
| | | p-toluenesulfonic acid | 3.0 | 3.0 | 3.0 | 3.0 | 3.0 | 5.0 | 6.5 | |
| | | Ethanol | 2.5 | 2.8 | 2.0 | 2.5 | 2.0 | 7.0 | 3.0 | 5.0 |
| | | Propylene glycol | 4.5 | 5.0 | 6.0 | 4.0 | 4.0 | 1.0 | 2.0 | 2.0 |
| | | Magnesium chloride · 6H₂O | 5.0 | 5.0 | 4.5 | 5.0 | 5.0 | 1.0 | 4.0 | |
| | | Sodium chloride | | 0.5 | 0.5 | | | | 1.0 | |
| | | Polypropylene glycol | | | | | | | | 1.0 |
| | | Perfume | 0.20 | 0.20 | 0.20 | 0.20 | 0.20 | 0.20 | 0.20 | 0.20 |
| | | Preservative | 0.01 | 0.01 | 0.01 | 0.01 | 0.01 | 0.01 | 0.01 | 0.01 |
| | | Deionized water | Balance | Balance | Balance | Balance | Balance | Balance | Balance | Balance |
| | | Total | 100 | 100 | 100 | 100 | 100 | 100 | 100 | 100 |
| | Total amount of surfactants | | 41.1 | 40.5 | 45.5 | 41.5 | 43.5 | 40.5 | 43 | 46 |
| | Viscosity | Stock solution | 630 | 550 | 600 | 500 | 600 | 200 | 550 | 160 |
| | (20° C., | 80 weight-% dilution | 820 | 750 | 830 | 600 | 700 | 160 | 620 | 200 |
| | mpa · s) | 60 weight-% dilution | 1200 | 1100 | 1200 | 750 | 800 | 100 | 300 | 210 |
| | | 40 weight-% dilution | 1500 | 1350 | 1400 | 900 | 1800 | 40 | 180 | 240 |
| | | 20 weight-% dilution | 100 | 100 | 90 | 1100 | 200 | 10 | 40 | 300 |
| | | 10 weight-% dilution | 20 | 20 | 15 | 300 | 60 | 5 | 5 | 60 |

| | | | | | | | | |
|---|---|---|---|---|---|---|---|---|
| pH (20° C.) | 6.7 | 6.5 | 6.6 | 6.7 | 6.4 | 7.8 | 6.8 | 6.4 |
| Amount of alkali metal and | 2.9 | 3.2 | 3.1 | 3.1 | 3 | 2.3 | 3.1 | 1.8 |
| alkaline earth metal(weight-%) | | | | | | | | |

| Detergent test | 14 | 15 | 16 | 15 | 16 | 9 | 11 | 8 |
|---|---|---|---|---|---|---|---|---|
| (number of dishes) | | | | | | | | |
| (Note) | | | | | | | | |
| The symbols in the table indicate the following compounds: | | | | | | | | |
| ES-I: Polyoxyethylene alkyl ether sodium sulfate [The starting alcohol was an alcohol obtained by hydroformylation of a mixture of 1-decene and 1-dodecene 50/50 (ratio by weight) as the starting material. About two EO molecules were added to the alcohol, and the product was then sulfurated with sulfur trioxide and neutralized with sodium hydroxide. The | | | | | | | | |
| # proportion of the total polyoxyethylene branched alkyl ether sodium sulfate in the total polyoxyethylene alkyl ether sodium sulfate was 42% by weight.] | | | | | | | | |

ES-II: Polyoxyethylene coconut alkyl ether ammonium sulfate (average number of EO molecules added: 2).
ES-III: Polyoxyethylene lauryl ether ammonium sulfate (average number of EO molecules added: 4).
AS: Ammonium lauryl sulfate.
AO-I: N-lauryl-N,N-dimethylamine oxide.
AO-II: Lauric acid amide propyl amine oxide.
Nonion-I: C₁₂₋₁₃ alkyl secondary alcohol to which about 7 EO moles were added (Softal 70, manufactured by Nippon Shokubai Co., Ltd.).
Nonion-II: Alkyl glucoside having C₁₂/C₁₄ (=60/40) alkyl groups wherein the average degree of condensation of glycoside is 1.5.
Nonion-IlI: Decanol to which about 8 EO molecules were added.
Betaine: Lauryl dimethyl acetate betaine.
Amide propyl betaine: Lauric acid amide propyl betaine.
Sulfobetaine: Lauryl dimethyl hydroxy sulfobetaine.
Fatty acid diethanol amide: Palm kernel oil fatty acid diethanol amide.
Polypropylene glycol: Weight-average molecular weight, 1200.
Preservative: Proxel BDN (Apicia Co., Ltd.)
pH: Adjusted with 1 N aqueous sulfuric acid or 1 N sodium hydroxide.

1. A liquid detergent composition for use in direct impregnation of a flexible absorber, which comprises 30 to 60% by weight of a surfactant, 0.01 to 5% by weight of a hydrotropic agent, 0.01 to 10% by weight of a water-soluble organic solvent and water, has a viscosity of 300 to 1000 mPa·s at 20° C. and has the maximum viscosity at 20° C., when diluted with water, within the concentration range of 10 to 60% by weight.

2. The liquid detergent composition according to claim 1, wherein the maximum viscosity at 20° C. when diluted with water is more than 1000 and not greater than 2500 mPa·s.

3. The liquid detergent composition according to claim 1 or 2, which comprises 15 to 50% by weight of a polyoxyalkylene alkyl ether sulfate having a C₁₀₋₁₆ alkyl group.

4. The liquid detergent composition according to claim 3, wherein the polyoxyalkylene alkyl ether sulfate has a branched primary alkyl group.

5. The liquid detergent composition according to claim 3 or 4, which comprises 0.5 to 10% by weight of an alkali metal and/or an alkaline earth metal and 1 to 10% by weight of an amine oxide-based surfactant.

6. The liquid detergent composition according to claim 5, wherein the polyoxyalkylene alkyl ether sulfate/amine oxide-based surfactant ratio by weight is from 2/1 to 10/1.

7. The liquid detergent composition according to claim 5 or 6, wherein the amine oxide-based surfactant is represented by the following formula (i): 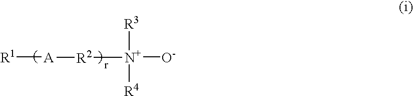
wherein R¹ represents a C₈₋₁₆ linear alkyl or alkenyl group, R³ and R⁴ each represent a C₁₋₃ alkyl or hydroxyalkyl group, R² represents a C₁₋₅ alkylene group, A is a group selected from —COO—, —CONH—, —OCO—, —NHCO— and —O— and r is a number of 0 or 1.

8. The liquid detergent composition according to any of claims 1 to 7, which comprises a betaine amphoteric surfactant.

9. A method of washing a hard surface by using a flexible absorber impregnated with the liquid detergent composition according to claim 1 and water.

10. The method according to claim 9, wherein the maximum viscosity of the liquid detergent composition at 20° C. when diluted with water is more than 1000 and not greater than 2500 mPa·s.
